(19) United States
(12) Patent Application Publication
(10) Pub. No.: US 2026/0181393 A1
(43) Pub. Date: Jun. 25, 2026

(54) METHODS FOR CREATING PIN, NETWORK ELEMENTS, UE, AND STORAGE MEDIA

(71) Applicant: Beijing Xiaomi Mobile Software Co., Ltd., Beijing (CN)

(72) Inventor: Jianning LIU, Beijing (CN)

(73) Assignee: Beijing Xiaomi Mobile Software Co., Ltd., Beijing (CN)

(21) Appl. No.: 18/848,230

(22) PCT Filed: Mar. 25, 2022
(86) PCT No.: PCT/CN2022/083201

§ 371 Date: Sep. 18, 2024

(51) Int. Cl. H04W 12/08

(52) U.S. Cl. CPC H04W 12/08

(57) ABSTRACT

The present disclosure provides methods for creating a personal IoT network (PIN), network elements, a user equipment (UE), and storage medium media. In an aspect, a method includes: receiving a service request for a PIN sent by a user equipment (UE), and checking a PIN service authorization of the UE; in response to the UE having the PIN service authorization, sending a PIN create request to a second network element; where the PIN create request is carried in the service request; and receiving a response to the PIN create request sent by the second network element, and sending a service acceptance message to the UE; where the service acceptance message carries the response, and the response carries at least a configuration of PIN parameters.

### CROSS REFERENCE TO RELATED APPLICATIONS

The present application is a U.S. national phase of International Application No. PCT/CN2022/083201, filed on Mar. 25, 2022, the disclosure of which is incorporated herein by reference in its entirety for all purposes.

### TECHNICAL FIELD

The present disclosure relates to a technology, and in particular to methods for creating a personal Internet of Things (IoT) network (PIN), network elements, a user equipment (UE), and storage media.

### BACKGROUND

A personal Internet of Things (IoT) network (PIN) consists of PIN elements that communicate using a PIN direct connection or a direct network connection, and is managed locally using one or more PIN elements with a management capability. Examples of PINs include networks of wearables and smart home/smart office equipment. Via a PIN element with a gateway capability, PIN elements have access to 5G network services and can communicate with PIN elements that are not within range to use the PIN direct connection. A PIN includes at least one PIN element with gateway capability (PEGC) and at least one PIN element with management capability (PEMC).

### SUMMARY

In view of this, the embodiments of the present disclosure provide methods for creating a personal Internet of Things (IoT) network (PIN), network elements, a user equipment (UE), and storage media.

According to a first aspect of the present disclosure, there is provided a method for creating a PIN, performed by a first network element. The method includes: receiving a service request for a PIN sent by a user equipment (UE), and checking a PIN service authorization of the UE; in response to the UE having the PIN service authorization, sending a PIN create request to a second network element; where the PIN create request is carried in the service request; and receiving a response to the PIN create request sent by the second network element, and sending a service acceptance message to the UE; where the service acceptance message carries the response, and the response carries at least a configuration of PIN parameters.

According to a second aspect of the present disclosure, there is provided a method for creating a PIN, performed by a second network element. The method includes: receiving a PIN create request sent by a first network element and configuring PIN parameters. In some exemplary embodiments, the method further includes: receiving a checking request for a PIN service authorization for a user equipment (UE) sent by the first network element, and checking the PIN service authorization of the UE; and sending a checking result to the first network element.

According to a third aspect of the present disclosure, there is provided a method for creating a PIN, performed by a UE. The method includes: sending a service request for a PIN to a first network element; receiving a service acceptance message sent by the first network element, and obtaining PIN parameters based on the service acceptance message; and updating a local response configuration based on the PIN parameters.

According to a fourth aspect of the present disclosure, there is provided a first network element, including a processor, a memory, and an executable program stored on the memory and executable by the processor. The processor performs the steps of the method as described in the first aspect when running the executable program.

According to a fifth aspect of the present disclosure, there is provided a second network element, including a processor, a memory, and an executable program stored on the memory and executable by the processor. The processor performs the steps of the method as described in the second aspect when running the executable program.

According to a sixth aspect of the present disclosure, there is provided a UE, including a processor, a transceiver, a memory, and an executable program stored on the memory and executable by the processor. The processor performs the steps of the method as described in the third aspect when running the executable program.

According to a seventh aspect of the present disclosure, there is provided a storage medium on which an executable program is stored. When the executable program is executed by a processor, the steps of the method described in the first aspect, the second aspect, or the third aspect are implemented.

In the technical solution of the embodiments of the present disclosure, based on the service request for the PIN sent by the UE, the network element at the network side determines whether the service requested by the UE is authorized, and configures the PIN parameters for the UE if authorized. The UE updates the local response configuration based on the PIN parameters. The embodiments of the present disclosure create a PIN network in a 5G system based on the request according to an operator or an authorized 3^{rd} party, allocates PIN parameters through a unified data management (UDM), and thus corresponding PIN services can be developed. The embodiments of the present disclosure expand application scenarios of the Internet of Things and improve the service quality of the 5G system.

### BRIEF DESCRIPTION OF THE DRAWINGS

The accompanying drawings, which are incorporated into and constitute a part of the specification, illustrate embodiments in accordance with the embodiments of the present disclosure and together with the specification, serve to explain the principles of the embodiments of the present disclosure.

FIG. 1 is a schematic structural diagram of a wireless communication system according to an exemplary embodiment.

FIG. 2 is a flowchart of a method for creating a PIN according to an exemplary embodiment.

FIG. 3 is a flowchart of a method for creating a PIN according to an exemplary embodiment.

FIG. 4 is a flowchart of a method for creating a PIN according to an exemplary embodiment.

FIG. 5 is a flowchart of a method for creating a PIN according to an exemplary embodiment.

FIG. 6 is a schematic structural diagram of an apparatus for creating a PIN according to an exemplary embodiment.

FIG. 7 is a schematic structural diagram of an apparatus for creating a PIN according to an exemplary embodiment.

FIG. 8 is a schematic structural diagram of an apparatus for creating a PIN according to an exemplary embodiment.

FIG. 9 is a schematic structural diagram of a UE according to an exemplary embodiment.

### DETAILED DESCRIPTION OF THE EMBODIMENTS

The exemplary embodiments will be described in detail herein, and examples thereof are shown in accompanying drawings. When the following descriptions refer to the accompanying drawings, unless otherwise indicated, the same numbers in different drawings represent the same or similar elements. The implementations described in the following exemplary embodiments do not represent all the implementations consistent with the embodiments of the present disclosure. Rather, they are merely examples of the apparatus and method consistent with some aspects of the embodiments of the present disclosure as detailed in the appended claims.

Terms used in the embodiments of the present disclosure are for the purpose of describing specific embodiments only, and are not intended to limit the embodiments of the present disclosure. The singular forms “a”, “an” and “this” used in the embodiments of the present disclosure and the appended claims are also intended to include plural forms, unless the context clearly indicates other meanings. It should also be understood that the term “and/or” as used herein refers to and includes any and all possible combinations of one or more of the associated listed items.

It should be understood that although terms first, second, third, etc. may be used in the embodiments of the present disclosure to describe various information, such information should not be limited to these terms. These terms are only used to distinguish the same type of information from each other. For example, first information may also be referred to as second information, and similarly, the second information may also be referred to as the first information without departing from the scope of the present disclosure. Depending on the context, the word “if” as used herein can be interpreted as “at the time of”, “when” or “in response to determining”.

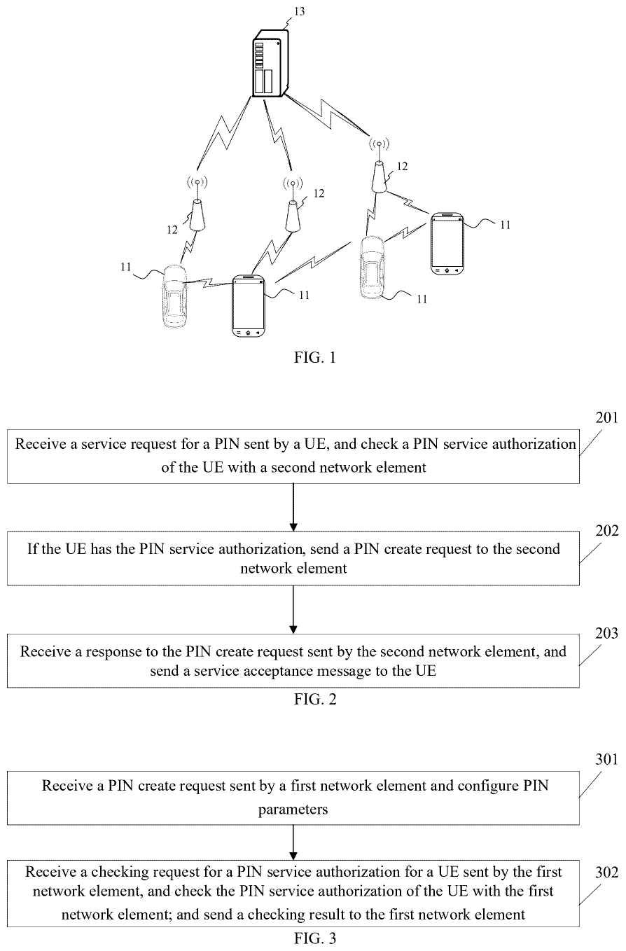

Referring to FIG. 1, FIG. 1 is a schematic structural diagram showing a wireless communication system provided in an embodiment of the present disclosure. As shown in FIG. 1, the wireless communication system is a communication system based on cellular mobile communication technology, and may include several terminals 11 and several base stations 12.

The terminal 11 may be a device that provides voice and/or data connectivity to a user. The terminal 11 may communicate with one or more core networks via a radio access network (RAN). The terminal 11 may be an Internet of Things terminal, such as a sensor device, a mobile phone (or a “cellular” phone) and a computer with an Internet of Things terminal. For example, the terminal 11 may be a fixed, portable, pocket-sized, handheld, built-in computer or vehicle-mounted apparatus, for example, a station (STA), a subscriber unit, a subscriber station, a mobile station, a mobile, a remote station, an access point, a remote terminal, an access terminal, a user terminal, a user agent, a user device, or user equipment (UE). Or, the terminal 11 may be a device of an unmanned aerial vehicle. Or, the terminal 11 may be a vehicle-mounted device, for example, a driving computer with a wireless communication function, or a wireless communication device externally connected with a driving computer. Or, the terminal 11 may be a roadside device, such as a street lamp, a signal lamp or other roadside devices with a wireless communication function.

The base station 12 may be a network side device in the wireless communication system. The wireless communication system may be a 4th generation mobile communication (4G) system, also referred to as a long term evolution (LTE) system. Or, the wireless communication system may be a 5G system, also referred to as a new radio (NR) system or a 5G NR system. Or, the wireless communication system may be any generation system. The access network in the 5G system may be referred to as a new generation-radio access network (NG-RAN) or a machine type communication (MTC) system.

The base station 12 may be an evolved base station (eNB) used in the 4G system. Or, the base station 12 may be a centralized distributed architecture base station (gNB) used in the 5G system. When the base station 12 adopts the centralized distributed architecture, it usually includes a central unit (CU) and at least two distributed units (DUs). A protocol stack of a packet data convergence protocol (PDCP) layer, a radio link control (RLC) layer and a media access control (MAC) layer is provided in the central unit. A protocol stack of a physical (PHY) layer is provided in the distributed unit. The specific implementation of the base station 12 is not limited in the embodiments of the present disclosure.

A wireless connection may be established between the base station 12 and the terminal 11 through a wireless radio. In different embodiments, the wireless radio is a wireless radio based on the 4th generation mobile communication network technology (4G) standard. Or, the wireless radio is a wireless radio based on the 5th generation mobile communication network technology (5G) standard. For example, the wireless radio is a new radio. Or, the wireless radio may also be a wireless radio based on the next generation mobile communication network technology standard of the 5G.

In some embodiments, an end to end (E2E) connection may also be established between terminals 11, for example, a vehicle to vehicle (V2V) communication, a vehicle to infrastructure (V2I) communication and a vehicle to pedestrian (V2P) communication in a vehicle to everything (V2X) communication.

In some embodiments, the above wireless communication system may further include a network management device 13.

Executing subjects involved in the embodiments of the present disclosure include but are not limited to a user equipment (UE) in a cellular mobile communication system and a base station in a cellular mobile communication system, etc.

FIG. 2 is a flowchart of a method for creating a personal Internet of Things (IoT) network (PIN) according to an exemplary embodiment. As shown in FIG. 2, the method for creating the PIN in the embodiment of the present disclosure is applied to a first network element, and the method includes steps 201 to 203.

In step 201, a service request for a PIN sent by a UE is received, and a PIN service authorization of the UE is checked with a second network element.

In the embodiment of the present disclosure, the first network element can include an access and mobility management function (AMF). Those skilled in the art should understand that, when other network elements in a core network implement functions of the AMF, they can also be enabled as the first network element. Or, if other network elements in the core network are configured with corresponding functions of the first network element in the embodiment of the present disclosure, they can also be enabled as the first network element. The second network element can include a unified data management (UDM). Those skilled in the art should understand that, when other network elements in the core network are configured with corresponding functions of the second network element in the embodiment of the present disclosure, they can also be enabled as the second network element.

As an implementation, the first network element and the second network element check the PIN service authorization of the UE, including at least one of the following: checking with the second network element whether the UE is authorized to create a PIN; checking with the second network element whether the UE is authorized to use a PIN service; or checking with the second network element whether the UE subscribes to the PIN service.

In step 202, if the UE has the PIN service authorization, a PIN create request is sent to the second network element.

In the embodiment of the present disclosure, the PIN create request is carried in the service request.

If the UE has no the PIN service authorization, a rejection message is sent to the UE. The rejection message includes at least one of the following: a rejection identifier or a reason value.

In step 203, a response to the PIN create request sent by the second network element is received, and a service acceptance message is sent to the UE.

In the embodiment of the present disclosure, the service acceptance message carries the response, which at least carries a configuration of PIN parameters.

The PIN parameters include at least one of the following: PIN information or PIN element information.

As an implementation, the PIN element information in the PIN parameters can include one or more pieces of PIN element information, each of which includes at least one of the following: a PIN element identifier, a PIN element type, one or more services provided by a PIN element, PIN element validity time, or a PIN element name.

As an implementation, the PIN element type includes at least one of the following: a PIN element with gateway capability (PEGC); a PIN element with management capability (PEMC); or a normal PIN element.

As an implementation, the PIN information includes at least one of the following: a PIN identifier, a PIN name, a PIN service, or PIN validity time.

As an example, a format of the PIN information can be implemented through the following manner:

```
PIN info: {
- PIN ID
  - PIN name
      - PIN Service(s), ,.
    - PIN valid time,
      - PINE List info {
          - PINE ID,
          - PINE type,
          - Service,
          - valid time,
          - PINE name.
        }
```

FIG. 3 is a flowchart of a method for creating a PIN according to an exemplary embodiment. As shown in FIG. 3, the method for creating the PIN in the embodiment of the present disclosure is applied to a second network element, and the method includes steps 301 and 302.

In step 301, a PIN create request sent by a first network element is received and PIN parameters are configured.

In the embodiment of the present disclosure, the second network element can include a unified data management (UDM). Those skilled in the art should understand that, when other network elements in a core network are configured with corresponding functions of the second network element in the embodiment of the present disclosure, they can also be enabled as the second network element. The first network element can include an access and mobility management function (AMF). Those skilled in the art should understand that, when other network elements in the core network implement functions of the AMF, they can also be enabled as the first network element. Or, if other network elements in the core network are configured with corresponding functions of the first network element in the embodiment of the present disclosure, they can also be enabled as the first network element.

In the embodiment of the present disclosure, the PIN parameters configured by the UDM include at least one of the following: PIN information or PIN element information.

As an implementation, the PIN element information in the PIN parameters can include one or more pieces of PIN element information, each of which includes at least one of the following: a PIN element identifier, a PIN element type, one or more services provided by a PIN element, PIN element validity time, or a PIN element name.

As an implementation, the PIN element type includes at least one of the following: a PIN element with gateway capability (PEGC); a PIN element with management capability (PEMC); or a normal PIN element.

As an implementation, the PIN information includes at least one of the following: a PIN identifier, a PIN name, a PIN service, or PIN validity time.

In step 302, a checking request for a PIN service authorization for a UE sent by the first network element is received, and the PIN service authorization of the UE is checked with the first network element; and a checking result is sent to the first network element.

In the embodiment of the present disclosure, checking the PIN service authorization of the UE with the first network element includes at least one of the following: checking with the first network element whether the UE is authorized to create a PIN; checking with the first network element whether the UE is authorized to use a PIN service; or checking with the first network element whether the UE subscribes to the PIN service.

FIG. 4 is a flowchart of a method for creating a PIN according to an exemplary embodiment. As shown in FIG. 4, the method for creating the PIN in the embodiment of the present disclosure is applied to a UE, and the method includes steps 401 to 403.

In step 401, a service request for a PIN is sent to a first network element.

In the embodiment of the present disclosure, the UE sends the service request for the PIN to the first network element in response to a user's operation or its own related configuration. Specifically, the UE sends the service request for the PIN to the first network element through a base station.

The first network element can include an access and mobility management function (AMF). Those skilled in the art should understand that, when other network elements in a core network implement functions of the AMF, they can also be enabled as the first network element. Or, if other network elements in the core network are configured with corresponding functions of the first network element in the embodiment of the present disclosure, they can also be enabled as the first network element.

In step 402: a service acceptance message sent by the first network element is received, and PIN parameters are obtained based on the service acceptance message.

In the embodiment of the present disclosure, the PIN parameters include at least one of the following: PIN information or PIN element information.

As an implementation, the PIN element information in the PIN parameters can include one or more pieces of PIN element information, each of which includes at least one of the following: a PIN element identifier, a PIN element type, one or more services provided by a PIN element, PIN element validity time, or a PIN element name.

As an implementation, the PIN element type includes at least one of the following: a PIN element with gateway capability (PEGC); a PIN element with management capability (PEMC); or a normal PIN element.

As an implementation, the PIN information includes at least one of the following: a PIN identifier, a PIN name, a PIN service, or PIN validity time.

In step 403, a local response configuration is updated based on the PIN parameters.

The UE updates the local response configuration based on the PIN parameters configured at the network side.

The specific implementation of the methods for creating the PIN in the embodiments of the present disclosure is further described below through specific examples.

The current key issue intends to support the management of the PIN, including the management of different types of PIN elements and the configuration of the PIN. Both a network operator and an authorized 3^{rd} party, i.e., a PIN element with management capability (PEMC) could create and configure the PIN and its elements.

After a PIN has been created, the PEMC can add a PEGC into the PIN, or remove a PEGC from the PIN, as well as add a PIN element into the PIN and associate the PIN element to some PEGCs that have already been added into the PIN, or remove a PIN element from the PIN. The key issue is to study the following aspects in the 5G.

How to support mechanisms for a network operator or authorized 3^{rd} party (e.g., a PEMC) for PIN management, e.g., create/modify/delete/activate/deactivate a PIN, etc.

How to support for the management of PIN elements, including add/remove the PIN elements, as well as the association between PEGC and other PIN elements.

How to support establishing and enforcing a validity duration and time validity of a PIN (e.g., the PIN is valid for 30 minutes, the PIN is valid from 15:00 UTC to 23:00 UTC) and a validity duration and time validity of PIN elements in a PIN (e.g., a PIN element will be a member of a PIN for 1 hour, the PIN element will be the member of the PIN from 16:00 UTC to 17:00 UTC).

The essence of the technical solution of the embodiments of the present disclosure will be further clarified with specific examples.

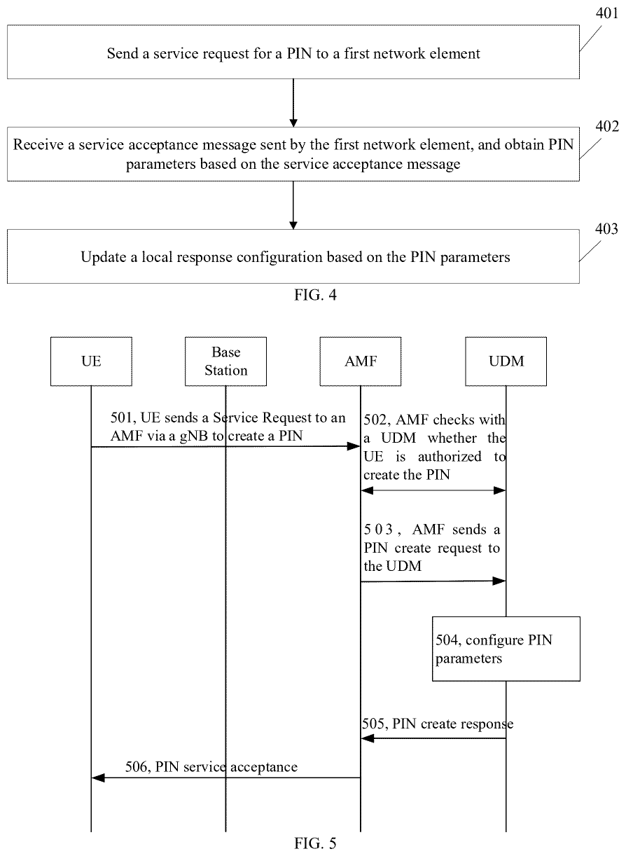

FIG. 5 is a flowchart of a method for creating a PIN according to an exemplary embodiment. As shown in FIG. 5, the embodiment of the present disclosure includes the following processing procedure.

In step 501, a UE 510 sends a Service Request to an access and mobility management function (AMF 514) via a gNB 512 to create a PIN.

The Service Request includes a PIN create request, which carries a PIN name, a PIN service, and one or more pieces of PIN element (PINE) information.

The PIN name is readable information for a user.

The PIN service: a list of services that PINE(s) can provide, e.g., printer, lamp, camera, etc.

The one or more pieces of PINE information, each of which includes at least one of the following elements:
a PINE ID, an unique ID within a PIN that allocated by the PEMC;
a PINE type, indicating whether a PINE is a PEMC, or a PEGC, or a normal PINE;
a PINE service, what the PINE can provide, e.g., printer, or lamp, or camera, etc.;
valid time, how long for the PINE to be as a member in the PIN;
a PINE name, human readable information, e.g., printer in bedroom, or lamp in living room.

In step 502, the AMF checks with a unified data management (UDM 516) whether the UE is authorized to create the PIN, or whether the UE is authorized to use the PIN service, or whether the UE subscribes to the PIN service. If no the AMF rejects the UE with cause.

In step 503, the AMF sends a PIN create request to the UDM to request for creating the PIN. The PIN create request carries the aforementioned PIN name, PIN service, PINE information, etc.

For example, PIN name, PIN service, PIN validity time, PINE list information.

In step 504, the UDM configures PIN parameters for the PIN create request of each UE, including allocating a PIN ID, and creating a PIN.

In step 505, the UDM sends a PIN create response to the AMF, responds to the PIN create request sent by the AMF, and notifies the AMF of a result of creating the PIN, which includes the PIN ID and a result for each PINE.

In step 506, the AMF sends a service acceptance to the UE via the gNB. The service acceptance carries a PIN create response. The PIN create response carries PIN parameters and the related configuration, including the PIN ID and the result for each PINE.

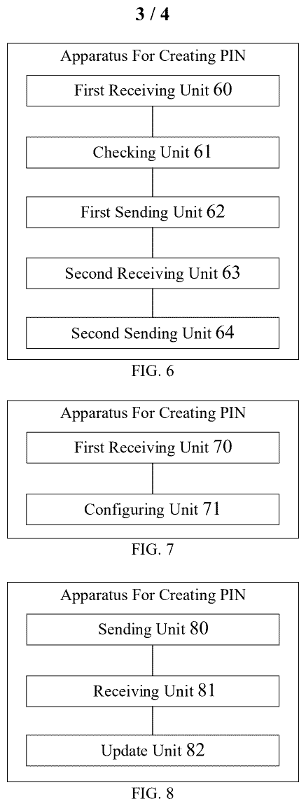

FIG. 6 is a schematic structural diagram of an apparatus for creating a PIN according to an exemplary embodiment. As shown in FIG. 6, the apparatus in the embodiment of the present disclosure is applied to a first network element and includes: a first receiving unit 60, configured to receive a service request for a PIN sent by a user equipment (UE); a checking unit 61, configured to check a PIN service authorization of the UE with a second network element; a first sending unit 62, configured to send, in response to the UE having the PIN service authorization, a PIN create request to the second network element; where the PIN create request is carried in the service request; a second receiving unit 63, configured to receive a response to the PIN create request sent by the second network element and trigger a second sending unit 64; and the second sending unit 64, configured to send a service acceptance message to the UE; where the service acceptance message carries the response, and the response carries at least a configuration of PIN parameters.

In some exemplary embodiments, the checking unit 61 is further configured to: check with the second network element whether the UE is authorized to create a PIN; and/or check with the second network element whether the UE is authorized to use a PIN service; and/or check with the second network element whether the UE subscribes to the PIN service.

In some exemplary embodiments, the apparatus further includes: a third sending unit (not shown in FIG. 6), configured to send a rejection message to the UE in response to the UE having no the PIN service authorization.

In some exemplary embodiments, the rejection message includes at least one of the following: a rejection identifier or a reason value.

In some exemplary embodiments, the PIN parameters include at least one of the following: PIN information or PIN element information.

In some exemplary embodiments, the PIN element information includes one or more pieces of PIN element information, and each of the one or more pieces of PIN element information includes at least one of the following: a PIN element identifier, a PIN element type, one or more services provided by a PIN element, PIN element validity time, or a PIN element name.

In some exemplary embodiments, the PIN element type includes at least one of the following: a PIN element with gateway capability (PEGC); a PIN element with management capability (PEMC); or a normal PIN element.

In some exemplary embodiments, the PIN information includes at least one of the following: a PIN identifier, a PIN name, a PIN service, or PIN validity time.

In an exemplary embodiment, the first receiving unit 60, the checking unit 61, the first sending unit 62, the second receiving unit 63, the second sending unit 64, the third sending unit, and the like may be implemented by one or more central processing units (CPUs), graphics processing units (GPUs), baseband processors (BPs), application specific integrated circuits (ASICs), digital signal processors (DSPs), programmable logic devices (PLDs), complex programmable logic devices (CPLDs), field-programmable gate arrays (FPGAs), general purpose processors, controllers, micro controller units (MCUs), microprocessors or other electronic components, and can also be combined with one or more radio frequency (RF) antennas to perform the steps of the aforementioned method for creating a PIN.

In the embodiment of the present disclosure, the specific manner in which each unit in the apparatus shown in FIG. 6 performs operations has been described in detail in the embodiment related to this method, and will not be elaborated here.

FIG. 7 is a schematic structural diagram of an apparatus for creating a PIN according to an exemplary embodiment. As shown in FIG. 7, the apparatus in the embodiment of the present disclosure is applied to a second network element and includes: a first receiving unit 70, configured to receive a PIN create request sent by a first network element; and a configuring unit 71, configured to configure PIN parameters.

In some exemplary embodiments, the apparatus further includes: a second receiving unit (not shown in FIG. 7), configured to receive a checking request for a PIN service authorization for a user equipment (UE) sent by the first network element; a checking unit (not shown in FIG. 7), configured to check the PIN service authorization of the UE with the first network element; and a sending unit (not shown in FIG. 7), configured to send a checking result to the first network element.

In some exemplary embodiments, the checking unit is further configured to: check with the first network element whether the UE is authorized to create a PIN; and/or check with the first network element whether the UE is authorized to use a PIN service; and/or check with the first network element whether the UE subscribes to the PIN service.

In some exemplary embodiments, the PIN parameters include at least one of the following: PIN information or PIN element information.

In some exemplary embodiments, the PIN element information includes one or more pieces of PIN element information, and each of the one or more pieces of PIN element information includes at least one of the following: a PIN element identifier, a PIN element type, one or more services provided by a PIN element, PIN element validity time, or a PIN element name.

In some exemplary embodiments, the PIN element type includes at least one of the following: a PIN element with gateway capability (PEGC); a PIN element with management capability (PEMC); or a normal PIN element.

In some exemplary embodiments, the PIN information includes at least one of the following: a PIN identifier, a PIN name, a PIN service, or PIN validity time.

In an exemplary embodiment, the first receiving unit 70, the configuring unit 71, the checking unit, the sending unit, and the like may be implemented by one or more central processing units (CPUs), graphics processing units (GPUs), baseband processors (BPs), application specific integrated circuits (ASICs), digital signal processors (DSPs), programmable logic devices (PLDs), complex programmable logic devices (CPLDs), field-programmable gate arrays (FPGAs), general purpose processors, controllers, micro controller units (MCUs), microprocessors or other electronic components, and can also be combined with one or more radio frequency (RF) antennas to perform the steps of the aforementioned method for creating a PIN.

In the embodiment of the present disclosure, the specific manner in which each unit in the apparatus shown in FIG. 7 performs operations has been described in detail in the embodiment related to this method, and will not be elaborated here.

FIG. 8 is a schematic structural diagram of an apparatus for creating a PIN according to an exemplary embodiment. As shown in FIG. 8, the apparatus in the embodiment of the present disclosure is applied to a UE and includes: a sending unit 80, configured to send a service request for a PIN to a first network element; a receiving unit 81, configured to receive a service acceptance message sent by the first network element and obtain PIN parameters based on the service acceptance message; and an update unit 82, configured to update a local response configuration based on the PIN parameters.

In some exemplary embodiments, the PIN parameters include at least one of the following: PIN information or PIN element information.

In some exemplary embodiments, the PIN element information includes one or more pieces of PIN element information, and each of the one or more pieces of PIN element information includes at least one of the following: a PIN element identifier, a PIN element type, one or more services provided by a PIN element, PIN element validity time, or a PIN element name.

In some exemplary embodiments, the PIN element type includes at least one of the following: a PIN element with gateway capability (PEGC); a PIN element with management capability (PEMC); or a normal PIN element.

In some exemplary embodiments, the PIN information includes at least one of the following: a PIN identifier, a PIN name, a PIN service, or PIN validity time.

In an exemplary embodiment, the sending unit 80, the receiving unit 81, the update unit 82, and the like may be implemented by one or more central processing units (CPUs), graphics processing units (GPUs), baseband processors (BPs), application specific integrated circuits (ASICs), digital signal processors (DSPs), programmable logic devices (PLDs), complex programmable logic devices (CPLDs), field-programmable gate arrays (FPGAs), general purpose processors, controllers, micro controller units (MCUs), microprocessors or other electronic components, and can also be combined with one or more radio frequency (RF) antennas to perform the steps of the aforementioned method for creating a PIN.

In the embodiment of the present disclosure, the specific manner in which each unit in the apparatus shown in FIG. 8 performs operations has been described in detail in the embodiment related to this method, and will not be elaborated here.

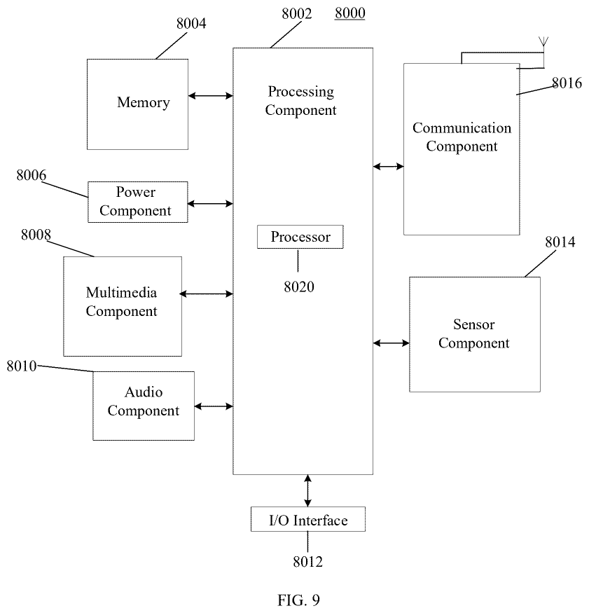

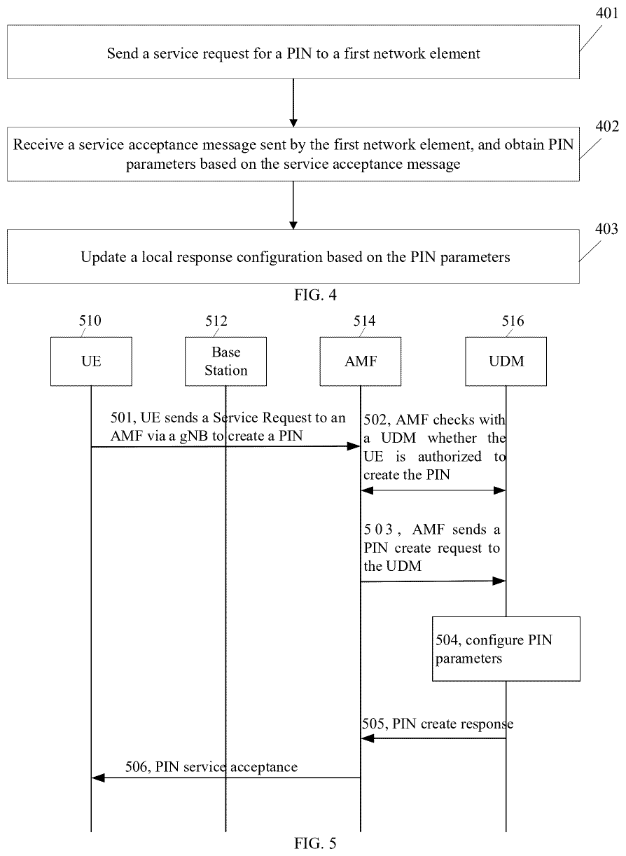

FIG. 9 is a block diagram of a UE 8000 according to an exemplary embodiment. For example, the UE 8000 may be a mobile phone, a computer, a digital broadcasting terminal, a messaging device, a game console, a tablet device, a medical device, a fitness device, a personal digital assistant, or the like.

Referring to FIG. 9, the UE 8000 can include one or more of the following elements: a processing element 8002, a memory 8004, a power element 8006, a multimedia element 8008, an audio element 8010, an input/output (I/O) interface 8012, a sensor element 8014, and a communication element 8016.

The processing element 8002 generally controls the overall operations of the UE 8000, such as operations associated with display, telephone calls, data communications, camera operations, and recording operations. The processing element 8002 can include one or more processors 8020 to execute instructions to complete all or part of the steps of the above methods. In addition, the processing element 8002 can include one or more modules to facilitate interaction between the processing element 8002 and other elements. For example, the processing element 8002 can include a multimedia module to facilitate interaction between the multimedia element 8008 and the processing element 8002.

The memory 8004 is configured to store various types of data to support operations at the UE 8000. Examples of such data include instructions for any application or method operating on the UE 8000, contact data, phone book data, messages, pictures, videos, and so on. The memory 8004 can be implemented by any type of volatile or non-volatile storage device or a combination thereof, such as static random access memory (SRAM), electrically erasable programmable read only memory (EEPROM), erasable programmable read only memory (EPROM), programmable read only memory (PROM), read only memory (ROM), magnetic memory, flash memory, magnetic disk or optical disk.

The power element 8006 provides power to various elements of the UE 8000. The power element 8006 can include a power management system, one or more power sources, and other elements associated with generating, managing, and distributing power for the UE 8000.

The multimedia element 8008 includes a screen that provides an output interface between the UE 8000 and a user. In some embodiments, the screen can include a liquid crystal display (LCD) and a touch panel (TP). If the screen includes a touch panel, the screen can be implemented as a touch screen to receive input signals from the user. The touch panel includes one or more touch sensors to sense touches, swipes, and gestures on the touch panel. The touch sensor can not only sense boundaries of a touch or swipe action, but also detect the duration and pressure related to the touch or swipe action. In some embodiments, the multimedia element 8008 includes a front camera and/or a rear camera. When the UE 8000 is in an operation mode, such as a shooting mode or a video mode, the front camera and/or the rear camera can receive external multimedia data. Each of the front and rear cameras can be a fixed optical lens system or have focal length and optical zooming capabilities.

The audio element 8010 is configured to output and/or input audio signals. For example, the audio element 8010 includes a microphone (MIC) that is configured to receive external audio signals when the UE 8000 is in an operation mode, such as a call mode, a recording mode, and a voice recognition mode. The received audio signals can be further stored in the memory 8004 or transmitted via the communication element 8016. In some embodiments, the audio element 8010 further includes a speaker for outputting audio signals.

The I/O interface 8012 provides an interface between the processing element 8002 and peripheral interface modules. The peripheral interface modules can be keyboards, a click wheels, a buttons, or the like. These buttons can include, but are not limited to, home button, volume button, start button, and lock button.

The sensor element 8014 includes one or more sensors for providing the UE 8000 with status assessment in various aspects. For example, the sensor element 8014 can detect an open/closed state of the UE 8000, relative positioning of elements, such as the display and keypad of the UE 8000. The sensor element 8014 can also detect a change in position of the UE 8000 or an element of the UE 8000, the presence or absence of user contact with the UE 8000, orientation or acceleration/deceleration of the UE 8000, and temperature change of the UE 8000. The sensor element 8014 can include a proximity sensor configured to detect the presence of nearby objects without any physical contact. The sensor element 8014 can also include a light sensor, such as a Complementary Metal-Oxide-Semiconductor (CMOS) or Charged Coupled Device (CCD) image sensor, for use in imaging applications. In some embodiments, the sensor element 8014 can further include an acceleration sensor, a gyro sensor, a magnetic sensor, a pressure sensor, or a temperature sensor.

The communication element 8016 is configured to facilitate wired or wireless communication between the UE 8000 and other devices. The UE 8000 can access a wireless network based on a communication standard, such as Wi-Fi, 2G, 3G, 4G or 5G, or a combination thereof. In an exemplary embodiment, the communication element 8016 receives broadcast signals or broadcast-related information from an external broadcast management system via a broadcast channel. In an exemplary embodiment, the communication element 8016 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an exemplary embodiment, the UE 8000 can be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components for performing the above methods.

In an exemplary embodiment, there is also provided a non-transitory computer readable storage medium including instructions, such as the memory 8004 including instructions executable by the processor 8020 of the UE 8000 to implement the above methods. For example, the non-transitory computer readable storage medium can be a ROM, a random access memory (RAM), a CD-ROM, a magnetic tape, a floppy disk, and an optical data storage device, etc.

An embodiment of the present disclosure also describes a first network element, including a processor, a transceiver, a memory, and an executable program stored on the memory and executable by the processor. The processor performs the steps of the method for creating a PIN in the aforementioned embodiments when runs the executable program.

An embodiment of the present disclosure also describes a second network element, including a processor, a transceiver, a memory, and an executable program stored on the memory and executable by the processor. The processor performs the steps of the method for creating a PIN in the aforementioned embodiments when runs the executable program.

An embodiment of the present disclosure also describes a terminal, including a processor, a transceiver, a memory, and an executable program stored on the memory and executable by the processor. The processor performs the steps of the method for creating a PIN in the aforementioned embodiments when runs the executable program.

An embodiment of the present disclosure also describes a storage medium on which an executable program is stored. The executable program is executed by a processor to perform the steps of the method for creating a PIN in the aforementioned embodiments.

Those skilled in the art will readily recognize other embodiments of the present disclosure upon consideration of the specification and practice of the present disclosure disclosed herein. The present disclosure is intended to cover any variations, uses, or adaptations of the present disclosure, which follow general principles of the embodiments of the present disclosure and include common knowledge or customary means in the art that are not disclosed in the present disclosure. The specification and embodiments are exemplary only, with the true scope and spirit of the present disclosure being indicated by the following claims.

It should be understood that the embodiments of the present disclosure is not limited to the precise structure that has been described above and shown in the drawings, and various modifications and changes may be made without departing from the scope thereof. The scope of the present disclosure is limited only by the appended claims.

1. A method for creating a personal IoT network (PIN), performed by a first network element, the method comprising:
receiving a service request for a PIN sent by a user equipment (UE), and checking a PIN service authorization of the UE;
in response to the UE having the PIN service authorization, sending a PIN create request to a second network element; wherein the PIN create request is carried in the service request; and
receiving a response to the PIN create request sent by the second network element, and sending a service acceptance message to the UE; wherein the service acceptance message carries the response, and the response carries at least a configuration of PIN parameters.

2. The method according to claim 1, wherein checking the PIN service authorization of the UE comprises:
checking whether the UE is authorized to create the PIN; and/or
checking whether the UE is authorized to use the PIN service; and/or
checking whether the UE subscribes to the PIN service.

3. The method according to claim 1, further comprising:
in response to the UE not having the PIN service authorization, sending a rejection message to the UE;
wherein the rejection message comprises at least one of: a rejection identifier or a reason value.

4. (canceled)

5. The method according to claim 1, wherein the PIN parameters comprise at least one of: PIN information or PIN element information.

6. The method according to claim 5, wherein the PIN element information comprises one or more pieces of PIN element information, and each of the one or more pieces of PIN element information comprises at least one of: a PIN element identifier, a PIN element type, one or more services provided by a PIN element, PIN element validity time, or a PIN element name;
wherein the PIN element type comprises at least one of:
a PIN element with gateway capability (PEGC);
a PIN element with management capability (PEMC); or
a normal PIN element.

7. (canceled)

8. The method according to claim 5, wherein the PIN information comprises at least one of: a PIN identifier, a PIN name, a PIN service, or PIN validity time.

9. A method for creating a personal IoT network (PIN), performed by a second network element, the method comprising:
receiving a PIN create request sent by a first network element and configuring PIN parameters;
wherein the method further comprises:
receiving a checking request for a PIN service authorization for a user equipment (UE) sent by the first network element, and checking the PIN service authorization of the UE; and
sending a checking result to the first network element.

10. (canceled)

11. The method according to claim 9, wherein checking the PIN service authorization of the UE comprises:
checking whether the UE is authorized to create a PIN; and/or
checking whether the UE is authorized to use a PIN service; and/or
checking whether the UE subscribes to the PIN service.

12. The method according to claim 9, wherein the PIN parameters comprise at least one of: PIN information or PIN element information.

13. The method according to claim 12, wherein the PIN element information comprises one or more pieces of PIN element information, and each of the one or more pieces of PIN element information comprises at least one of: a PIN element identifier, a PIN element type, one or more services provided by a PIN element, PIN element validity time, or a PIN element name;
wherein the PIN element type comprises at least one of:
a PIN element with gateway capability (PEGC);
a PIN element with management capability (PEMC); or
a normal PIN element.

14. (canceled)

15. The method according to claim 12, wherein the PIN information comprises at least one of: a PIN identifier, a PIN name, a PIN service, or PIN validity time.

16. A method for creating a personal IoT network (PIN), performed by a user equipment (UE), the method comprising:
sending a service request for a PIN to a first network element;
receiving a service acceptance message sent by the first network element, and obtaining PIN parameters based on the service acceptance message; and
updating a local response configuration based on the PIN parameters.

17. The method according to claim 16, wherein the PIN parameters comprise at least one of: PIN information or PIN element information.

18. The method according to claim 17, wherein the method further comprises at least one of:
the PIN element information comprises one or more pieces of PIN element information, and each of the one or more pieces of PIN element information comprises at least one of: a PIN element identifier, a PIN element type, one or more services provided by a PIN element, PIN element validity time, or a PIN element name; wherein the PIN element type comprises at least one of: a PIN element with gateway capability (PEGC); a PIN element with management capability (PEMC); or a normal PIN element; or
the PIN information comprises at least one of: a PIN identifier, a PIN name, a PIN service, or PIN validity time.

19.-23. (canceled)

24. A first network element, comprising:
a memory, and
an executable program stored on the memory; and
one or more processors that execute the executable program, wherein the executable program when collectively executed by the one or more processors, cause the first network element to perform the method according to claim 1.

25. A second network element, comprising:
a memory, and
an executable program stored on the memory; and
one or more processors that execute the executable program, wherein the executable program when collectively executed by the one or more processors, cause the second network element to perform the method according to claim 9.

26. A terminal, comprising:
a transceiver,
a memory, and
an executable program stored on the memory; and
one or more processors that execute the executable program, wherein the executable program when collectively executed by the one or more processors, cause the terminal to perform the method according to claim 16.

27. A non-transitory storage medium storing an executable program, wherein the executable program, when executed by a processor of the first network element, cause the first network element to perform the method according to claim 1.

28. A non-transitory storage medium storing an executable program, wherein the executable program, when executed by a processor of the second network element, cause the second network element to perform the method according to claim 9.

29. A non-transitory storage medium storing an executable program, wherein the executable program, when executed by a processor of the UE, cause the UE to perform the method according to claim 16.
